(19) United States
(12) Patent Application Publication
(10) Pub. No.: US 2007/0126251 A1
(43) Pub. Date: Jun. 7, 2007

(54) LOCK APPARATUS FOR A CHAIN GRAB HOOK

(75) Inventors: Brian R. Olson, Fort Qu'Appelle, SK (CA); Darold Eklund, Fort Qu'Appelle, SK (CA); Rose Shiels, Fort Qu'Appelle, SK (CA)

Correspondence Address: GRAY, PLANT, MOOTY, MOOTY & BENNETT, P.A., P.O. BOX 2906, MINNEAPOLIS, MN, 55402-0906, US

(73) Assignee: POWERPIN INC., Fort Qu'Appelle (CA)

(21) Appl. No.: 11/567,433

(22) Filed: Dec. 6, 2006

Related U.S. Application Data
(60) Provisional application No. 60/779,965, filed on Mar. 8, 2006.

(30) Foreign Application Priority Data
Dec. 6, 2005 (CA) 2528835

(51) Int. Cl. B66C 1/34

(52) U.S. Cl. 294/82.17

(57) ABSTRACT

A lock apparatus for a chain grab hook comprises a locking member adapted to be pivotally attached to the clevis of the chain grab hook about a pivot element located between a mid-point of the locking member and the top surface of the clevis. When installed, a bias element is operative to exert a bias force on the locking member urging the front end of the locking member to pivot upward to a closed position wherein the front end of the locking member extends into the open end of the jaw a sufficient distance to prevent a chain link engaged in the jaw from moving out of the open end of the jaw. The front end of the locking member can be pushed downward against the bias force to an open position to release the chain link from the jaw.

This invention relates to hooks for use with chains and in particular to locking devices for a chain grab hook to prevent an engaged chain link from slipping out of the grab hook.

### CROSS-REFERENCE TO RELATED APPLICATIONS

The present application is based on and claims priority from the Canadian patent application number 2,528,835 filed on Dec. 6, 2005, and from the US provisional application Ser. No. 60/779,965, filed Mar. 8, 2006.

### BACKGROUND

A typical chain for general use in securing loads, towing, and the like include a hook on each end to engage the chain. A grab hook will engage or grab the chain and form a loop of a desired substantially fixed size. The grab hook has an opening or jaw that has a width just slightly larger than the width of the chain link and long enough that a chain link will slide into the jaw, and the adjacent link of the chain will bear against the hook.

In contrast a slip hook has a larger rounded jaw through which the chain will slide to tighten a loop around an object within the loop. Chains are often stocked in bulk on rolls so that a customer can simply buy a chain of the desired length, and add a grab or slip hook to each end as desired for his particular application. Chain hooks therefore are commonly available in various sizes for attachment to corresponding sizes of chain by a clevis. The end link of the chain is inserted between the clevis arms and a clevis pin is inserted through bores in the clevis pin and through the end link, and secured by a cotter pin or the like.

It is often desired to lock the chain into the grab hook to prevent the chain link from slipping out of the jaw of the grab hook. U.S. Pat. No. 5,127,219 to Herron et. al. discloses a typical application where such a lock is used on a safety chain securing an agricultural implement to a tractor drawbar. The lock is provided by a wire formed latch engaging grooves on either side of the jaw of the hook. The lock and jaw are thus an integrated unit, and the lock is not adaptable to the conventional and commonly available grab hook with a clevis attachment.

U.S. Pat. No. 3,01,817 to Bambenek et al. discloses a lock mechanism that can be added to a conventional grab hook by attachment to the clevis pin. A resilient member is urged outward across the opening of the jaw to engage the free end of the hook such that lateral movement is prevented. To open the lock, the resilient member is pushed inward to disengage same from the free end of the hook so that same may be rotated to the side to allow a chain link to be removed from the jaw, or to insert a link to be locked in the jaw.

U.S. Pat. No. 6,019,408 to Bennett, Jr. also discloses a locking mechanism that can be added to a conventional grab hook by attachment to the clevis pin. The lock includes a spring biased member that engages the shank of the hook to prevent rotation of the locking member out of the opening of the jaw. Pressing against the spring bias disengages the shank and allows the locking member to rotate to allow insertion or removal of a chain link.

Such locking mechanisms for conventional grab hooks are also known where the clevis pin is spring loaded and the locking member defines a slot and a larger hole at one end of the slot. The clevis pin engages the larger hole and pushing against the pin disengages the pin from the larger hole and moves a narrower portion of the pin into alignment with the slot and allows locking member to slide out to open the jaw of the grab hook.

### SUMMARY OF THE INVENTION

It is an object of the present invention to provide a chain grab hook locking apparatus for a chain that overcomes problems in the prior art.

In a first embodiment the invention provides a lock apparatus adapted for installation on a chain grab hook, the chain grab hook having a clevis for attachment of the chain grab hook to a chain link, the clevis having a top surface adjacent to an open end of a jaw of the chain grab hook. The locking apparatus comprises a locking member adapted to be pivotally attached to a top surface of the clevis about a pivot element located between a mid-point of the locking member and the top surface of the clevis, and a bias element. When installed, the bias element is operative to exert a bias force on the locking member urging the front end of the locking member to pivot upward to a closed position wherein the front end of the locking member extends into the open end of the jaw a sufficient distance to prevent a chain link engaged in the jaw from moving out of the open end of the jaw. The front end of the locking member can be pushed downward against the bias force to an open position where the front end of the locking member is moved downward a sufficient distance to allow a chain link engaged in the jaw to move out of the open end of the jaw.

In a second embodiment the invention provides a lock apparatus adapted for installation on a chain grab hook, the chain grab hook having a clevis for attachment of the chain grab hook to a chain link, the clevis having a top surface adjacent to an open end of a jaw of the chain grab hook. The locking apparatus comprises a locking member defining a pin aperture in a rear portion thereof, and a clevis pin configured to be inserted through the pin aperture and bores of the clevis such that a head of the clevis pin bears against a top surface of the locking member. A pivot element is adapted to be located between the locking member and the top surface of the clevis forward of the pin aperture, and a bias element is operative to exert a bias force on the clevis pin urging the head of the clevis pin downward against the rear portion of the locking member and urging the locking member toward a closed position. When installed on a chain grab hook, the locking member is configured such that, when in the closed position, a front end of the locking member extends into the open end of the jaw a sufficient distance to prevent a chain link engaged in the jaw from moving out of the open end of the jaw, and such that pushing downward on a front portion of the locking member pivots the front portion of the locking member downward about the pivot element and pivots the rear portion of the locking member upward against the bias force to an open position where the front end of the locking member is moved downward a sufficient distance to allow a chain link engaged in the jaw to move out of the open end of the jaw.

In a third embodiment the invention provides a locking chain grab hook apparatus comprising a chain grab hook having a clevis for attachment of the chain grab hook to a chain link, the clevis having a top surface adjacent to an open end of a jaw of the chain grab hook. A locking member defines a pin aperture in a rear portion thereof, and a clevis pin passes downward through the pin aperture and bores of the clevis such that a head of the clevis pin bears against a top surface of the locking member. A pivot element is located between the locking member and the top surface of the clevis forward of the pin aperture, and a bias element is operative to exert a bias force on the clevis pin urging the head of the clevis pin downward against the rear portion of the locking member and urging the locking member toward a closed position. The locking member is configured such that, when in the closed position, a front end of the locking member extends into the open end of the jaw a sufficient distance to prevent a chain link engaged in the jaw from moving out of the open end of the jaw, and such that pushing downward on a front portion of the locking member pivots the front portion of the locking member downward about the pivot element and pivots the rear portion of the locking member upward against the bias force to an open position where the front end of the locking member is moved downward a sufficient distance to allow a chain link engaged in the jaw to move out of the open end of the jaw.

The invention provides a grab hook locking apparatus for installation on a conventional grab hook that includes a clevis for attachment to an end link of a chain. The grab hook is of the type configured to engage a chain link that is inserted laterally into the jaw of the grab hook.

If an outward force is exerted on a chain link that is locked into the jaw the link will contact the front end of the locking member and move the front end upward and completely compress the spring on the clevis pin such that further upward movement of the clevis pin and the front end of the locking member is prevented, and the chain link is retained in the jaw of the hook.

The apparatus of the invention thus provides convenient locking and unlocking of the chain link into the grab hook and prevents inadvertent disengagement. The apparatus is readily installed on commonly available conventional grab hooks with a clevis for attachment to a chain. The apparatus can be scaled up and down to provide a locking mechanism suitable for various chain sizes.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a side view of an embodiment of the chain grab hook locking apparatus of the present invention in the closed position with a chain link engaged in the grab hook;

FIG. 2 is a side view of the embodiment of FIG. 1 in the open position with a chain link partly engaged in the hook;

FIG. 3 is a side view of the embodiment of FIG. 1 in the closed position with the chain link experiencing a force in a direction to move same out of engagement with the hook;

FIG. 4 is a schematic end view of the embodiment of FIG. 1 in the closed position;

FIG. 5 is a top view of the locking member of the embodiment of FIG. 1;

FIG. 6 is a top view of grab hook of the prior art;

FIG. 7 is a top view of an alternate locking apparatus of the invention installed on the grab hook of FIG. 6;

FIG. 8 is a side view of the alternate locking apparatus of FIG. 7;

FIG. 9 illustrates an alternate embodiment of the chain grab hook locking apparatus of the present invention where the pivot element is provided by a pivot lug extending down from the locking member;

FIG. 10 illustrates a further alternate embodiment of the chain grab hook locking apparatus of the present invention where the pivot element is provided by a pivot lug provided by a pivot extension extending down from the locking member, and where the locking member pivots on the front corner of the extension.

### DETAILED DESCRIPTION OF THE ILLUSTRATED EMBODIMENTS

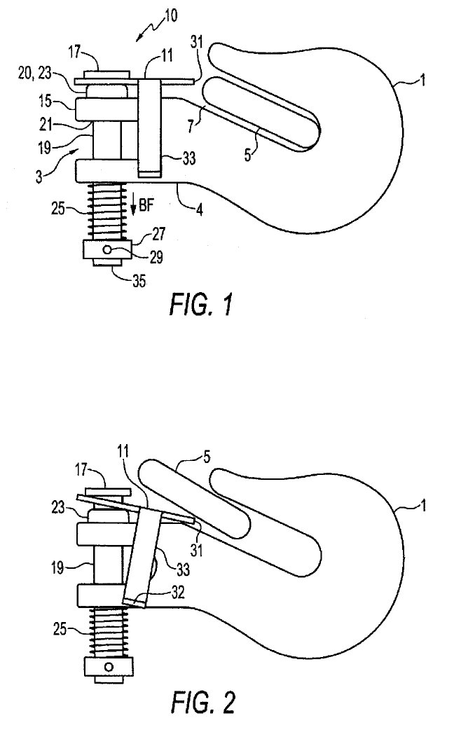

FIGS. 1-4 illustrate a conventional chain grab hook 1 with a clevis 3 for attachment to a chain. The chain grab hook 1 is of the type configured to engage a chain link 5 that is inserted laterally into the jaw 7 of the grab hook 1. A lock apparatus 10 of the invention is adapted for installation on the chain grab hook, and comprises a locking member 11 adapted to be pivotally attached to a top surface of the clevis 3 about a pivot element located between a mid-point of the locking member and the top surface of the clevis 3.

The locking member 11, further illustrated in FIG. 5, defines a pin aperture 13 in a rear portion thereof. The locking member 11 is attached to the top member 15 of the clevis 3 adjacent to the open end of the jaw 7 by the head 17 of a clevis pin 19 inserted through the pin aperture 13 and the bores 21 of the clevis 3. The head 17 of the clevis pin 19 bears against a top surface of the locking member 11

In order to allow the locking member 11 to pivot from the closed position of FIG. 1 to the open position of FIG. 2 a pivot element 20 is located between the locking member 11 and the top member 15 of the clevis 3 forward of the pin aperture 13. In the embodiment of FIGS. 1-5 the pivot element 20 is provided by a pivot washer 23 located between the locking member 11 and the top of the clevis 3.

A bias element, provided by a spring 25 in the illustrated embodiment, is operative to exert a bias force BF on the clevis pin 19 urging the head 17 of the clevis pin 19 downward against the rear portion of the locking member 11 and urging the locking member 11 toward the closed position shown in FIG. 1. The bottom end of the clevis pin 19 under the clevis 3 extends through the spring 25 and is secured by a collar 27 attached to the clevis pin 19 by a roll pin 29 or the like. The spring 25 exerts the downward bias force BF on the clevis pin 19 and urges the head 17 of the clevis pin 19 downward on the locking member 11 and thus urges the locking member 11 downward against the pivot washer 23.

The locking member 11 is configured such that when in the closed position illustrated in FIG. 1, the head 17 of the clevis pin 19 holds the locking member 11 flat against the pivot washer 23. The locking member 11 is then oriented substantially parallel with the top of the clevis 3 and the front end 31 of the locking member 11 extends into or across the open end of the jaw 7 a sufficient distance to prevent a chain link 5 engaged in the jaw 7 from moving out of the open end of the jaw 7 and thus out of engagement with the hook 1.

The pivot element 20, provided by the pivot washer 23 keeps the front portion of the locking member 11 above the top of the clevis 3 so that the locking member 11 has room to pivot downward on the front end 31 thereof. Pushing downward on the front portion of the locking member 11 pivots the front portion of the locking member 11 downward about the pivot washer 23 and pivots the rear portion of the locking member upward against the bias force BF of the spring 25 to an open position, illustrated in FIG. 2, where the front end 31 of the locking member 11 is moved downward a sufficient distance to allow a chain link 5 engaged in the jaw 7 to move out of the open end of the jaw 7.

To facilitate pushing down on the front portion of the locking element, the illustrated embodiment includes tabs 33 attached to the front portion of the locking member 11 and configured such that the tabs 33 are exposed sufficiently to allow fingers of an operator to push down on the tabs 33 to move the front portion of the locking member down to the open position.

The pin aperture 13 in the locking member 11 is somewhat larger in diameter than the clevis pin 19 to allow the locking member 11 to pivot up and down. Similarly when engaging the chain link 5 in the hook, pushing and sliding the chain link 11 against the top of the locking member 11 or pressing down on the tabs 33 or up on the bottom end 35 of the clevis pin 19 will pivot the locking member 11 down to the open position to allow the chain link 5 to move into the jaw 7.

The illustrated tabs 33 extend downward on each side of the shank 4 of the chain grab hook 1 and then bottom portions thereof, wings 32, extend outward such that each tab 33 can be conveniently gripped with a finger while pressing upward on the bottom end 35 of the clevis pin 19 with the thumb to release or engage a chain link 5. The downward extending tabs 33 on each side of the shank 4 also serve to maintain the locking member 11 in the proper orientation with respect to the hook 1 by preventing the locking member 11 from rotating about the clevis pin 19.

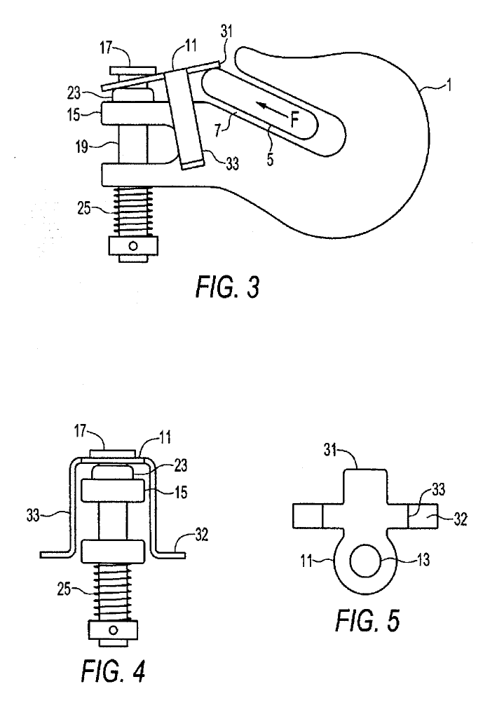

As illustrated in FIG. 3, when an outward force F is exerted on a chain link 5 that is locked into the jaw 7, the link 5 will contact the front end 31 of the locking member 11 and move the front end 31 upward and completely compress the spring 25 on the clevis pin 19 such that further upward movement of the clevis pin 19 and the front end 31 of the locking member 11 is prevented, and the chain link 5 is retained in the jaw 7 of the hook 1.

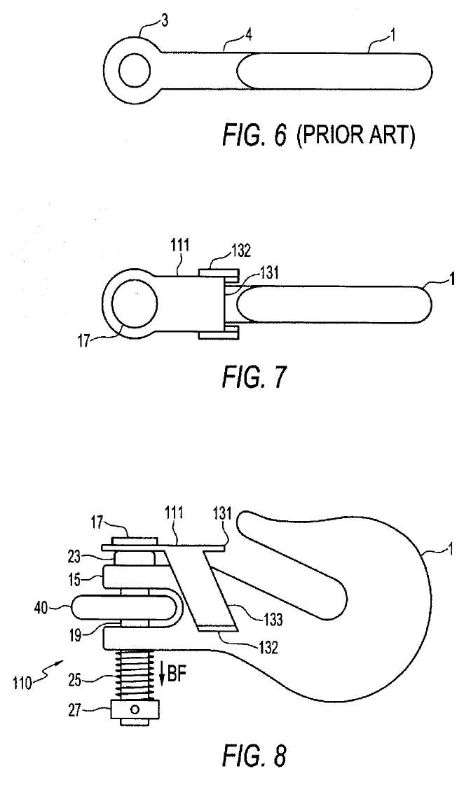

FIG. 6 illustrates a top view of the conventional grab hook 1 of FIG. 1 with a clevis 3 for attachment to a chain. As can be seen in this view, the clevis 3 is significantly wider than the shank 4 of the grab hook 1.

FIGS. 7 and 8 illustrate an alternate embodiment of the locking apparatus 110 of the present invention comprising a locking member 111 attached to the top member 15 of the clevis by the head 17 of a clevis pin 19 inserted through the clevis 3. As above, the pivot element is provided again by pivot washer 23 located between the locking member 111 and the top of the clevis 3. Spring 25 is secured to the bottom end of the clevis pin 19 under the bottom of the clevis 3 by a collar 27. The spring 25 exerts a downward bias force BF on the clevis pin 19 and urges the head 17 of the clevis pin 19 downward on the locking member 111 and urging the locking member 111 downward against the pivot washer 23.

The locking member 111 is configured such that when in the closed position illustrated in FIG. 8, same is oriented substantially parallel with the top of the clevis 3 and a front end 131 of the locking member 111 extends into the open end of the jaw 7 a sufficient distance to prevent a chain link engaged in the jaw from moving out of engagement with the hook 1. Again, the pivot washer 23 keeps the locking member 111 above the top of the clevis 3 so that the locking member 111 can pivot downward on the front end 131 thereof.

As can be seen in FIGS. 7 and 8, the front portion of the locking member 111 located forward of the clevis 3 is narrow, substantially the same width as the shank 4, such that the tabs attached 133 are located in close proximity to the sides of the shank 4 of the grab hook 1, and slope forward such that they can be pushed downward with a chain link 40 engaged in the clevis 3. The wings 132 extending outward from the bottom ends of the tabs 133 are also narrow. Thus the alternate locking apparatus 110 of FIGS. 7 and 8 takes up less lateral space than the locking apparatus 10 of FIGS. 1-5, and can be used advantageously in locations where space is restricted.

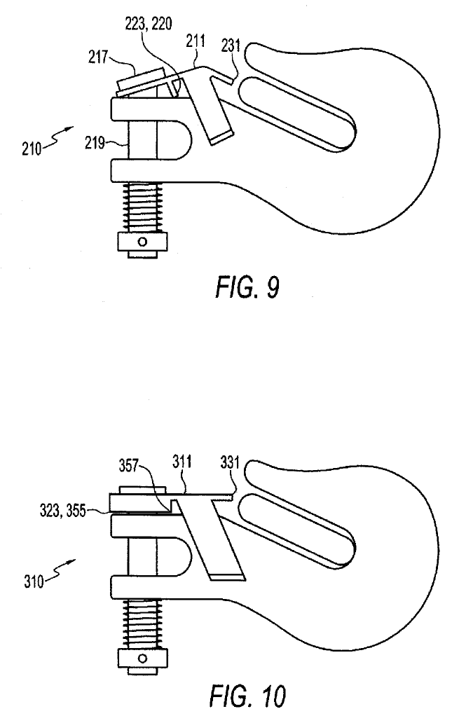

FIG. 9 illustrates an alternate embodiment of the apparatus 210 where the pivot element 220 is provided by a pivot lug 223 on a bottom surface of the locking member 211 forward of the pin aperture. The locking member 211 is shown in the closed position. Pushing down on the front end 231 of the locking member 211 causes the locking member 211 to pivot about the lug 223. The clevis pin 219 here has a head 217 that is oriented at an angle as illustrated in order to bear against the top surface of the locking member 211 which is oriented at the same angle.

FIG. 10 illustrates a further alternate embodiment of the apparatus 310 where the pivot lug 323 comprises a pivot extension 355 extending downward from the rear portion of the locking member 311 such that a front bottom corner 357 of the pivot extension 355 is located under a mid point of the locking member 311. Essentially the locking member 311 in this embodiment of the apparatus 310 has a rear portion that is thicker than the front portion. The locking member 311 is shown in the closed position. Pushing down on the front end 331 of the locking member 311 causes the locking member 311 to pivot about the front bottom corner 357.

The foregoing is considered as illustrative only of the principles of the invention. It is intended that all matter contained in the above description or shown in the accompanying drawing shall be interpreted as illustrative and not in a limiting sense. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A lock apparatus adapted for installation on a chain grab hook, the chain grab hook having a clevis for attachment of the chain grab hook to a chain link, the clevis having a top surface adjacent to an open end of a jaw of the chain grab hook, the locking apparatus comprising:
a locking member defining a pin aperture in a rear portion thereof;
a clevis pin configured to be inserted through the pin aperture and bores of the clevis such that a head of the clevis pin bears against a top surface of the locking member;
a pivot element adapted to be located between the locking member and the top surface of the clevis forward of the pin aperture;
a bias element operative to exert a bias force on the clevis pin urging the head of the clevis pin downward against the rear portion of the locking member and urging the locking member toward a closed position;
wherein when installed on a chain grab hook, the locking member is configured such that, when in the closed position, a front end of the locking member extends into the open end of the jaw a sufficient distance to prevent a chain link engaged in the jaw from moving out of the open end of the jaw, and such that pushing downward on a front portion of the locking member pivots the front portion of the locking member downward about the pivot element and pivots the rear portion of the locking member upward against the bias force to an open position where the front end of the locking member is moved downward a sufficient distance to allow a chain link engaged in the jaw to move out of the open end of the jaw.

2. The apparatus of claim 1 wherein the pivot element is provided by a pivot washer adapted to be located between the top surface of the clevis and the locking member, with the clevis pin passing through the pivot washer.

3. The apparatus of claim 1 wherein the pivot element is provided by a pivot lug on a bottom surface of the locking member forward of the pin aperture.

4. The apparatus of claim 3 wherein the pivot lug comprises a pivot extension extending downward from a rear portion of the locking member such that a front bottom corner of the pivot extension is located under a mid point of the locking member and such that the rear portion of the locking member is thicker than the front portion of the locking member.

5. The apparatus of claim 1 comprising tabs attached to the front portion of the locking member and configured such that the tabs are exposed sufficiently to allow fingers of an operator to push down on the tabs to move the front portion of the locking member down to the open position.

6. The apparatus of claim 5 wherein the tabs extend downward from each side of the front portion of the locking member such that, when installed, a shank of the chain grab hook is between the tabs, and wherein wings on bottom ends of each tab extend outward from the shank.

7. The apparatus of claim 6 wherein the clevis is wider than the shank, and wherein the front portion of the locking member has a width substantially equal to a width of the shank, and wherein the tabs slope downward and forward toward a closed end of the jaw in close proximity to the shank.

8. The apparatus of claim 1 wherein a bottom end of the clevis pin extends through a spring and wherein the spring exerts the bias force between a bottom surface of the clevis and the clevis pin.

9. A locking chain grab hook apparatus comprising:
a chain grab hook having a clevis for attachment of the chain grab hook to a chain link, the clevis having a top surface adjacent to an open end of a jaw of the chain grab hook;
a locking member defining a pin aperture in a rear portion thereof;
a clevis pin passing downward through the pin aperture and bores of the clevis such that a head of the clevis pin bears against a top surface of the locking member;
a pivot element located between the locking member and the top surface of the clevis forward of the pin aperture;
a bias element operative to exert a bias force on the clevis pin urging the head of the clevis pin downward against the rear portion of the locking member and urging the locking member toward a closed position;
wherein the locking member is configured such that, when in the closed position, a front end of the locking member extends into the open end of the jaw a sufficient distance to prevent a chain link engaged in the jaw from moving out of the open end of the jaw, and such that pushing downward on a front portion of the locking member pivots the front portion of the locking member downward about the pivot element and pivots the rear portion of the locking member upward against the bias force to an open position where the front end of the locking member is moved downward a sufficient distance to allow a chain link engaged in the jaw to move out of the open end of the jaw.

10. The apparatus of claim 9 wherein the pivot element is provided by a pivot washer located between the top surface of the clevis and the locking member, and wherein the clevis pin passes through the pivot washer.

11. The apparatus of claim 9 wherein the pivot element is provided by a pivot lug on a bottom surface of the locking member forward of the pin aperture.

12. The apparatus of claim 11 wherein the pivot lug comprises a pivot extension extending downward from a rear portion of the locking member such that a front bottom corner of the pivot extension is located under a mid point of the locking member and such that the rear portion of the locking member is thicker than the front portion of the locking member.

13. The apparatus of claim 9 comprising tabs attached to the front portion of the locking member and configured such that the tabs are exposed sufficiently to allow fingers of an operator to push down on the tabs to move the front portion of the locking member down to the open position.

14. The apparatus of claim 13 wherein the tabs extend downward from each side of the front portion of the locking member such that, when installed, a shank of the chain grab hook is between the tabs, and wherein wings on bottom ends of each tab extend outward from the shank.

15. The apparatus of claim 14 wherein the clevis of the chain grab hook is wider than the shank of the chain grab hook, and wherein the front portion of the locking member has a width substantially equal to a width of the shank, and wherein the tabs slope downward and forward toward a closed end of the jaw in close proximity to the shank.

16. The apparatus of claim 9 wherein a bottom end of the clevis pin extends through a spring and wherein the spring exerts the bias force between a bottom surface of the clevis and the clevis pin.

17. A lock apparatus adapted for installation on a chain grab hook, the chain grab hook having a clevis for attachment of the chain grab hook to a chain link, the clevis having a top surface adjacent to an open end of a jaw of the chain grab hook, the locking apparatus comprising:
a locking member adapted to be pivotally attached to a top surface of the clevis about a pivot element located between a mid-point of the locking member and the top surface of the clevis; and
a bias element;
wherein when installed, the bias element is operative to exert a bias force on the locking member urging the front end of the locking member to pivot upward to a closed position wherein the front end of the locking member extends into the open end of the jaw a sufficient distance to prevent a chain link engaged in the jaw from moving out of the open end of the jaw;
wherein the front end of the locking member can be pushed downward against the bias force to an open position where the front end of the locking member is moved downward a sufficient distance to allow a chain link engaged in the jaw to move out of the open end of the jaw.

18. The apparatus of claim 17 wherein the a locking member is pivotally attached to a top surface of the clevis by a clevis pin configured to be inserted through a pin aperture in a rear portion of the locking member and through bores of the clevis such that a head of the clevis pin bears against a top surface of the locking member.

19. The apparatus of claim 18 wherein the bias element is operative to exert a bias force on the clevis pin urging the head of the clevis pin downward against the rear portion of the locking member and urging the front end of the locking member upward.

20. The apparatus of claim 19 wherein the pivot element is provided by a pivot washer located between the top surface of the clevis and the locking member, and wherein the clevis pin passes through the pivot washer.
